(19) United States
(12) Patent Application Publication
(10) Pub. No.: US 2026/0101065 A1
(43) Pub. Date: Apr. 9, 2026

(54) TECHNIQUES FOR MEMORY CONSERVATION WHEN STORING PREDICTION DATA FROM MOTION COMPENSATION-BASED PREDICTIVE CODING

(71) Applicant: APPLE INC., Cupertino, CA (US)

(72) Inventors: Yeqing WU, Cupertino, CA (US); Yunfei ZHENG, Santa Clara, CA (US); Alexandros TOURAPIS, Los Gatos, CA (US); Yixin DU, Milpitas, CA (US); Hilmi Enes EGILMEZ, Santa Clara, CA (US); Guoxin JIN, San Diego, CA (US); Guichun LI, San Jose, CA (US); Aki KUUSELA, Cupertino, CA (US)

(21) Appl. No.: 19/331,232

(22) Filed: Sep. 17, 2025

Related U.S. Application Data
(60) Provisional application No. 63/702,985, filed on Oct. 3, 2024.

(51) Int. Cl. H04N 19/61; H04N 19/105; H04N 19/109; H04N 19/139; H04N 19/172; H04N 19/176; H04N 19/182; H04N 19/423

(52) U.S. Cl. CPC H04N 19/61; H04N 19/105; H04N 19/109; H04N 19/139; H04N 19/172; H04N 19/176; H04N 19/182; H04N 19/423

(57) ABSTRACT

Aspects of the present disclosure include techniques for reducing memory requirements for motion vector prediction. Motion vectors may be represented and stored using transform functions or using motion vector differentials. Additionally, motion vectors may be scaled, thus allowing the reference frame index to be discarded (e.g., not stored in memory). Also, a determination may be made whether the motion vector is/are used again, and based on an indicator (e.g., flag), the motion vector(s) may be discarded. Other techniques, including subsampling and alternating reference frames for storage, are also described herein.

### CLAIM FOR PRIORITY

This application claims priority to application Ser. No. 63/702,985, filed Oct. 3, 2024 and entitled “Techniques For Memory Conservation When Storing Prediction Data From Motion Compensation-Based Predictive Coding,” the disclosure of which is incorporated herein in its entirety.

### TECHNICAL FIELD

This application is directed to motion compensation-based predictive coding, and more particularly, to reducing memory requirements for prediction data generated as part of motion compensation-based predictive coding.

### BACKGROUND

In video sequences, there may be a strong correlation between pixel values across successive frames or within a single frame. This correlation is particularly notable when video frames are densely sampled spatially or temporally, such as in high-resolution or high-frame-rate videos. To enhance video compression efficiency by removing spatial and temporal redundancy, various methods are employed in existing video coding standards. One of the most significant techniques is motion compensation-based predictive coding.

Motion compensation-based predictive coding technique aims to predict coding blocks in a current frame or picture by leveraging one or more matching blocks from its reference frames. The encoder accomplishes this through a motion estimation process, determining appropriate parameters (e.g., motion vectors) that may need to be transmitted to the decoder. The actual motion compensation and prediction processes occur in both the encoder and decoder, utilizing the prediction parameters to generate the prediction signal. Oftentimes, frames are partitioned into spatial arrays of one or more pixels (called “pixel blocks,” for convenience), and the motion prediction processes are performed on a pixel block by pixel block basis.

To further refine the prediction, residual coding may be employed to reduce any remaining errors. Additionally, loop filtering techniques can be applied to mitigate discontinuities or other artifacts that may arise from or remain after the residual coding process.

The motion compensation-based inter-predictive coding algorithm exploits temporal redundancy among content in successive frames. Additionally, it can eliminate inter-layer and/or spatial redundancy when applied in scalable coding, intra-block copy prediction, or fractal-based image/video coding scenarios. However, inter-prediction methods often require signaling multiple pieces of motion information per coding block, including reference frame indices, motion models, and motion vectors (MVs). This increased side information may diminish the potential performance gains from inter-prediction, as motion information can introduce significant signaling overhead and account for a large portion of the final bitstream.

To mitigate the overhead associated with signaling motion information, existing video coding standards leverage spatial motion vector prediction (SMVP) and temporal motion vector prediction (TMVP) to enhance the coding efficiency of motion information. In SMVP, motion information among pixel blocks in video sequences often exhibits strong correlation with their spatial neighbors. Hence, the motion information of neighboring pixel blocks in a frame can serve as a predictor for the motion information of the current pixel block in the same frame, thereby reducing redundancies in motion information.

In TMVP, strong temporal correlation exists between motion information from successive frames, particularly between motion information from reference frames. This temporal correlation can be exploited to improve motion vector prediction and, consequently, enhance the coding efficiency of pixel blocks in the current frame. In scenarios involving scalable or multi-view coding, TMVP may correspond to motion information from an earlier coded version of the current picture/view.

However, enabling TMVP requires storing the motion vector information of a coded frame in memory for the usage by future frames. This information comprises the motion vector and the reference frame index. In cases where a block is coded using bi-prediction, two motion vectors and two reference frame indices must be stored for TMVP. Existing video coding standards typically utilize multiple reference frames for inter prediction, necessitating the storage of motion information for each reference frame.

As a result, high-resolution video applications require significant amount of memory to store motion vector information for TMVP. This can lead to increased hardware implementation costs, particularly for mobile devices, and may pose challenges to hardware implementation if excessive memory consumption occurs due to TMVP.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example simplified block diagram of a system, in accordance with aspects of the present disclosure.

FIG. 2 illustrates a functional block diagram illustrating components of an encoding

terminal and a decoding terminal, in accordance with aspects of the present disclosure.

FIG. 3A and FIG. 3B illustrate flowcharts showing processes for storing data representing a reference frame, in accordance with aspects of the present disclosure.

FIG. 4 illustrates a graph showing an example of linear transformation of a motion vector component, in accordance with aspects of the present disclosure.

FIG. 5 illustrates a graph showing an example of non-linear transformation of a motion vector component, in accordance with aspects of the present disclosure.

FIG. 6 illustrates a compression operation, in accordance with aspects of the present disclosure.

FIG. 7 illustrates a compression operation, in accordance with aspects of the present disclosure.

FIG. 8 illustrates a compression operation, in accordance with aspects of the present disclosure.

FIG. 9A and 9B illustrate compression operations, in accordance with aspects of the present disclosure.

FIG. 10 illustrates a compression operation may be achieved by varying a precision of a motion vector according to observed motion within frame content, in accordance with aspects of the present disclosure.

FIG. 11 illustrates a compression operation, in accordance with aspects of the present disclosure.

FIG. 12 illustrates a compression operation according to another aspect of the present disclosure.

FIG. 13 illustrates a diagram of reference frames, showing an approach for storing motion vector, in accordance with aspects of the present disclosure.

FIG. 14 illustrates an exemplary application of a piecewise linear transform according to an aspect of the present disclosure.

FIG. 15 is a block diagram of an electronic device according to an aspect of the present disclosure.

FIG. 16 illustrates relationships between memory and other functional units of an

electronic device, according to an aspect of the present disclosure.

FIG. 17 is a block diagram of video encoding circuitry, according to an aspect of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Aspects of the present disclosure provide techniques for reducing memory requirements for motion vector prediction, including TMVP. Various techniques may include an application of a transform function to motion vectors (including motion vector components). Additionally, a motion vector difference MVD may be calculated between two motion vectors and the motion vector difference MVD may be stored in memory rather than at least one of the motion vectors. Further, motion vectors may be scaled, allowing the reference frame index to be discarded and not stored. Also, a flag may be applied to indicate precision of the level of precision be used for motion vector storage. Flags may also be utilized to determine whether to save some motion vectors. Motion vector components may be individually controlled, including allocating bits from one motion vector component to another when one all of the bits for a motion vector are not required. Also, reference frames may be subsampled prior to saving, which reduces the number of saved reference frames.

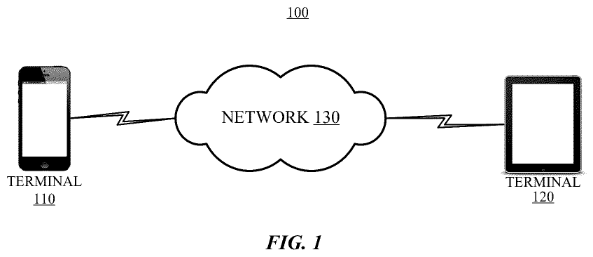

These and other embodiments are discussed below with reference to FIGS. 1-12. However, those skilled in the art will readily appreciate that the detailed description given herein with respect to these Figures is for explanatory purposes only and should not be construed as limiting.

FIG. 1 illustrates a simplified block diagram of a system 100 according to an aspect of the present disclosure. The system 100 may take the form of a video delivery system, an image delivery system, a video coding system, and/or a video decoding system. The system 100 may include a terminal 110 and a terminal 120 (each representative of one or more terminals) interconnected via a network 130. The terminals 110 and 120 may code video data for transmission to their counterparts via the network. Thus, the terminal 110 (e.g., transmitting terminal) may capture video data locally, code the video data and transmit the coded video data to the terminal 120 (e.g., receiving terminal) via a channel. The terminal 120 may receive the coded video data from the terminal 110, decode it, and consume it locally, for example, by rendering decoded video on a display at the terminal 120, by processing the decoded video by an application (not shown) executing on the terminal 120, or by storing it at the terminal 120 for later use. If the terminals 110 and 120 are engaged in bidirectional exchange of video data, then the terminal 120 (e.g., transmitting terminal) may capture video data locally, code the video data and transmit the coded video data to the terminal 110 (e.g., receiving terminal) via another channel. The terminal 110 may receive the coded video data transmitted from the terminal 120, decode it, and render it locally, for example, on its own display. The processes described herein may operate coding of on both frame pictures and interlaced field pictures but, for simplicity, the present discussion will describe the techniques in the context of integral frames.

The system 100 may be used in a variety of applications. In a first application, the terminals 110 and 120 may support real time bidirectional exchange of coded video to establish a video conferencing session between them. In another application, the terminal 110 may code pre-produced video (for example, television or movie programming) and store the coded video for delivery to one or, often, many downloading clients (e.g., the terminal 120). Thus, the video being coded may be live or pre-produced, and the terminal 110 may function as a media server, delivering the coded video according to a one-to-one or a one-to-many distribution model. For the purposes of the present discussion, the type of video and the video distribution schemes are immaterial unless otherwise noted.

In FIG. 1, the terminals 110 and 120 are illustrated as a personal computer and a smart phone, respectively, but the principles of the present disclosure are not so limited. Aspects of the present disclosure also find application with various types of computers (desktop, laptop, and tablet computers), computer servers, media players, dedicated video conferencing equipment, and/or dedicated video encoding equipment. Many techniques and systems described herein, such as the terminals 110 and 120 of the system 100, may operate on still images as well as video.

The network 130 represents any number of networks that convey coded video data between the terminals 110 and 120, including for example wireline and/or wireless communication networks. The communication network may exchange data in circuit-switched or packet-switched channels. Representative networks include telecommunications networks, local area networks, wide area networks, and/or the Internet. For the purposes of the present discussion, the architecture and topology of the network are immaterial to the operation of the present disclosure unless otherwise noted.

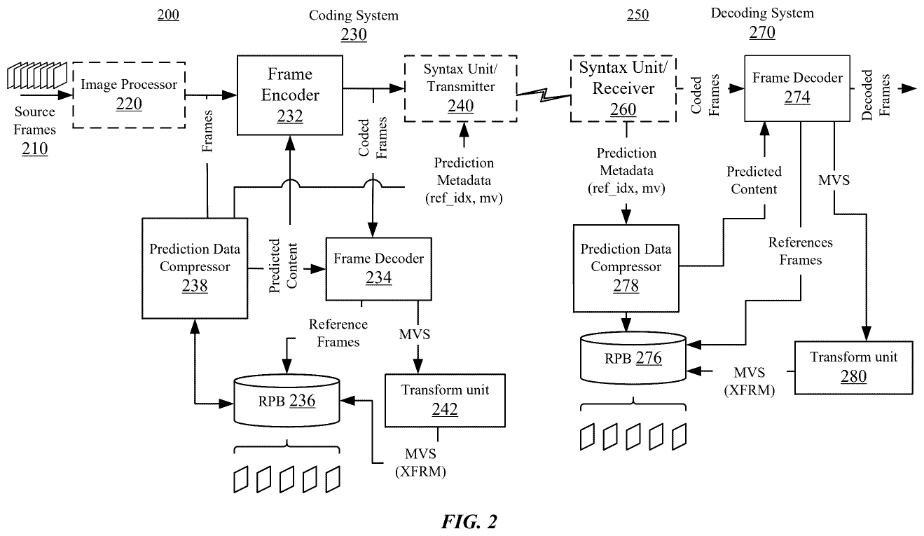

FIG. 2 illustrates a functional block diagram illustrating components of an encoding terminal 200 and a decoding terminal 250, in accordance with aspects of the present disclosure. The encoding terminal 200 and the decoding terminal 250 may find application in the system 100 of FIG. 1. The encoding terminal 200 may include source frames 210 (e.g., from a video source), an image processor 220, a coding system 230, and a syntax unit/transmitter 240. The source frames 210 may be provided from a camera that captures image data of a local environment, a storage device that stores video from some other source, a locally-executing application, or a network connection through which source video data is received. The image processor 220 may perform signal conditioning operations on the video 210 to be coded to prepare the video data for coding. For example, the image processor 220 may alter the frame rate, frame resolution, and/or other properties of the source video. The image processor 220 also may perform filtering operations on the source video.

The coding system 230 may perform coding operations on the video to reduce its bandwidth. Typically, the coding system 230 exploits temporal and/or spatial redundancies within the source video. For example, the coding system 230 may perform motion compensated predictive coding in which source frames 210 (or field frames) are parsed into sub-units (again, called “pixel blocks,” for convenience), and individual pixel blocks are coded differentially with respect to predicted pixel blocks, which are derived from previously-coded video data. A pixel block to be coded (a “current” pixel block) may be coded according to any one of a variety of predictive coding modes, such as: intra-coding, in which an input pixel block is coded differentially with respect to previously coded/decoded data of a common frame; single prediction inter-coding, in which an input pixel block is coded differentially with respect to data of a previously coded/decoded frame; and multi-hypothesis motion compensation predictive coding, in which an input pixel block is coded predictively using decoded data from two or more sources, via temporal or spatial prediction.

The predictive coding modes may be used cooperatively with other coding techniques, such as Transform Skip coding, RRU coding, scaling of prediction sources, palette coding, and the like.

The coding system 230 may include a frame encoder 232, a frame decoder 234, a reference picture buffer 236 (RPB), a prediction data compressor, and a transform unit 242. The prediction data compressor may perform prediction selections based on an analysis of an input frame's pixel blocks, and select prediction content to be used by the frame encoder 232. The prediction data compressor may output data representing its prediction selections, for example, a prediction mode and, where applicable, motion vector(s) to a syntax unit 240. The frame encoder 232 may apply the differential coding techniques to the input frame's pixel blocks using predicted content (e.g., pixel block) data supplied by the prediction data compressor. The frame decoder 234 may receive coded frames from the frame encoder 232 and, using the predicted content supplied by the prediction data compressor, invert the differential coding techniques applied by the frame encoder 232 yielding decoded frames designated as reference frames, which may be stored in the reference picture buffer 236. The coding system 230 also may store prediction selections generated by the prediction data compressor in the reference picture buffer 236. To this end, the frame decoder 234 may provide motion vectors (mvs) to the transform unit 242. The transform unit 242 may apply a transform function to the motion vectors, and provide the transformed motion vectors (mvs (xfrm)) to the reference picture buffer 236. Using the transform unit 242, the transformed motion vectors may be compressed, thus forming a reduced-sized representation of a prediction reference (e.g., motion vector(s)) and lowering memory requirements in the reference picture buffer 236. The reference picture buffer 236 may store the reconstructed reference frames for use in prediction operations, as well as the transformed motion vectors. The prediction data compressor may utilize stored transformed motion vector data when performing prediction operations for later-received frames 230.

The coding system 230 may generate coding parameters that identify coding selections performed by the coding system 230. With respect to prediction selections, for example, when the coding system 230 selects coding modes for its coding hypotheses, the coding system 230 may provide data to the syntax unit/transmitter 240 that identifies those coding modes. The coding system 230 may select motion vectors (including transformed motion vectors), representing spatial displacements between the current pixel block and a block from the reference picture buffer 236 that is selected as a prediction reference for the current pixel block. For SMVP, the prediction data compressor may supply motion vector data representing a spatial displacement between the current pixel block and a reference pixel block, which is to be found in the same frame in which the current pixel block is present. For TMVP, the prediction data compressor may supply data (ref_idx) representing frame(s) from which prediction data was selected and motion vector representing a spatial displacement between the current pixel block and a reference pixel block. Data identifying those motion vectors may be provided to the syntax unit/transmitter 240 and transmitted to the decoding terminal 250. The syntax unit/transmitter 240 may transmit coded video data to a decoding terminal via a channel.

The decoding terminal 250 may include a syntax unit/receiver 260 to receive coded video data from the channel and a decoding system 270 that decodes coded data. The syntax unit/receiver 260 may receive a data stream from the network (shown in FIG. 1) and may route components of the data stream to appropriate units within the decoding terminal 250. Although FIG. 2 illustrates functional units for video coding and decoding, terminals 110 and 120 (shown in FIG. 1) often will include coding/decoding systems for audio data associated with the video and perhaps other types of data (not shown). Thus, the syntax unit/receiver 260 may parse the coded video data from other elements of the data stream and route it to the frame decoder 274.

The decoding system 270 may perform decoding operations for coded video generated by the coding system 230. The decoding system 270 may include a frame decoder 272, a frame decoder 274, a reference picture buffer 276 (RPB), a prediction data compressor 278, and a transform unit 280. The prediction data compressor 278 may receive prediction metadata, such as an index (e.g., reference frame index (ref_idx)) and motion vector (mv), and use the prediction metadata to generate predicted content. The frame decoder 272 may receive coded frames from the syntax unit/receiver 260 as well as predicted content from the prediction data compressor 278 to generate decoded frames, which may be provided to a device, such as a client-side device (e.g., terminals 110a and 110b in FIG. 1) including a display, as a non-limiting example.

Similar to the frame decoder 234 of the coding system 230, the frame decoder 272 may provide reference frames to the reference frame buffer 276. Also, the frame decoder 272 may provide motion vectors (MVS) to the transform unit 280. The transform unit 280 may apply a transform function to the motion vectors, and provide the transformed motion vectors (MVS (XFRM)) to the reference picture buffer 276. Using the transform unit 280, the transformed motion vectors may be compressed, thus lowering memory requirements in the reference picture buffer 276. The reference picture buffer 276 may store the reconstructed reference frames for use in prediction operations, as well as the transformed motion vectors. The prediction data compressor 278 may predict data for current pixel blocks from within the reference frames stored in the reference picture buffer 276.

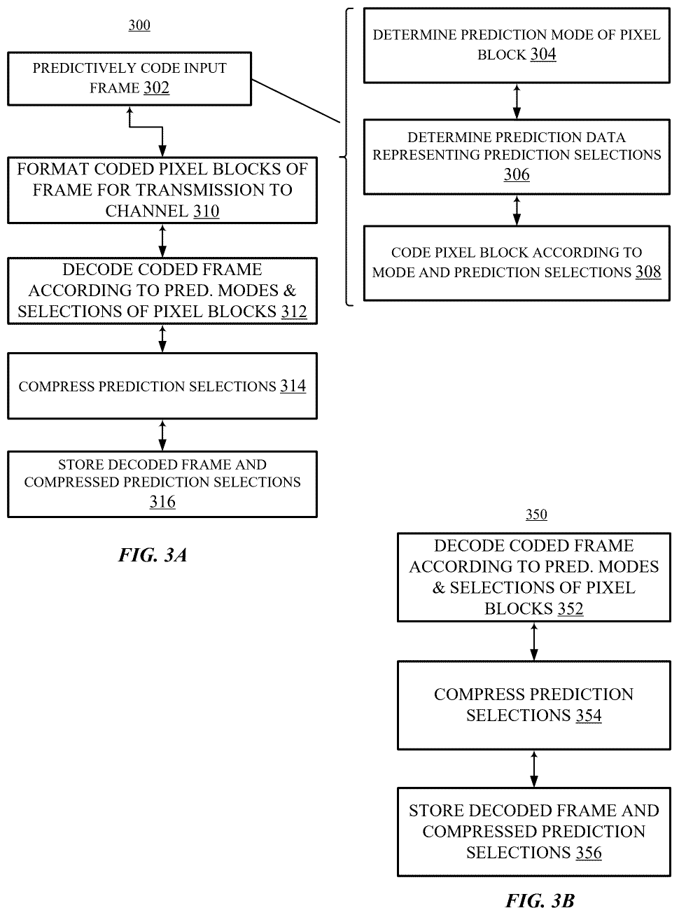

FIG. 3A and FIG. 3B illustrate flowcharts showing processes for storing data representing a reference frame, in accordance with aspects of the present disclosure. Referring to FIG. 3A, a process 300 is shown. At block 302, an input frame is predictively coded. Block 302 may include determining a prediction mode of a pixel block (block 304), determining prediction data representing prediction selections (block 306), and coding the pixel block according to the mode and prediction selections (block 308).

At block 310, coded pixel blocks of the frame are formatted for transmission to a channel. At block 312, the coded frames are decoded according to the prediction modes and the selections of pixel blocks. At block 314, the prediction selections are compressed. At block 316, the decoded frame and compressed prediction selections are stored.

Referring to FIG. 3B, a process 350 is shown. At block 352, coded frames are decoded according to prediction modes and selections of pixel blocks. At block 354, prediction selections are compressed. At block 356, decoded frame and compressed predictions are stored.

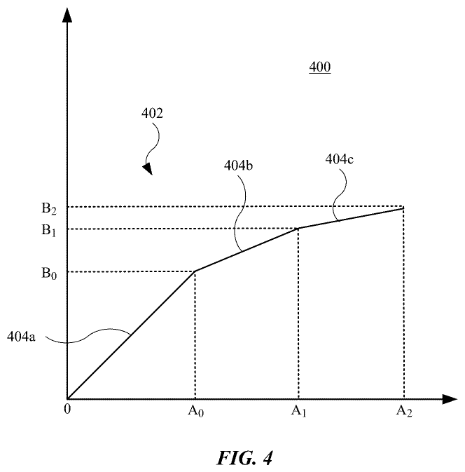

FIG. 4 illustrates a graph 400 showing an exemplary compression operation in accordance with aspects of the present disclosure. In this example, a motion vector component may be subject to a linear transformation that converts the motion vector component to a reduced-sized representation. In practice, a motion vector typically consists of two components: a vertical (y) component and a horizontal (x) component. Assuming that N bits are used to represent the value of each motion vector component, to compress the motion vector value of the component from N bits to M bits to save memory, where M <N, while maintaining high precision for smaller values and using lower precision for larger values without exceeding the budget of M bits for a motion vector component, a piecewise linear function may be applied to compress the motion vector component. A piecewise linear function is a function composed of several linear segments. Each linear segment, or linear piece, may map the input interval to the output interval with a different range.

In practice, it may be desirable to maintain high precision of motion vectors that have relatively small magnitudes within the vectors' source range. To maintain the precision of the motion vector component, equal linear mapping (e.g., a slope of 1) can be applied for motion vectors with relatively small values. However, for a motion vector component with a relatively large value, to keep the value within the bit budget of M bits, the linear piece transformation with a slope less than 1 can be applied to compress the motion vector component.

For example, the graph 400 shows a plot 402 of a transform function f (A) governed

by

$$f ( A ) = \{ \begin{matrix}\frac{B 0}{A 0} * A , & A < A 0 \\ \frac{B 1 - B 0}{A 1 - A 0} * ( A - A 0 ) + B 0 , & A 0 <= A < A 1 \\ \frac{B 2 - B 1}{A 2 - A 1} * ( A - A 1 ) + B 1 , & A 1 <= X < A 2\end{matrix} \qquad Eq . ( 1 )$$

where a segment 404a is a plot when A is less than A0, a segment 404b is a plot when A is greater than or equal to A0 and less than A1, and a segment 404c is a plot when A is greater than or equal to A1 and less than A2. The graph 400 represents a linear transformation, in different segments, of a motion vector component in which the slope of the transformation is less than 1 to maintain the value of the motion vector component within M bits. By maintain the value to within M bits, the memory required store the motion vector component is reduced. It is expected that, during implementation, the number of segments 404a, 404b, 404c and their slopes may be tuned to satisfy individual implementation needs.

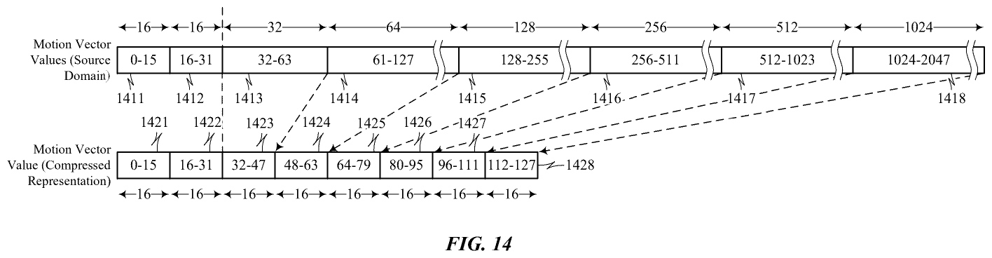

FIG. 14 illustrates an exemplary application of a piecewise linear transform. In this example, source motion vector can be compressed from a 13 bit source representation to an 8 bit converted representation before being stored in memory. The compressed motion vector values may be decompressed from the stored 8-bit representation to a 13-bit representation for use in further processing.

In this example, the source 13 bit representation may take values from 0-2048. The 13 bit source domain representation is converted to an 8 bit destination representation according to a piecewise linear transform. FIG. 14 illustrates source domain values of 0 to 2048 arranged into non-uniform bands 1411-1418. Specifically, the first 16 values (0-16) are shown as band 1411 and the second 16 values (17-31) are shown as band 1412. The values in these source domain bands 1411, 1412 may be converted to corresponding designation values 0-31 in the destination representation, shown as bands 1421 and 1422. No information loss arises from the conversation between bands 1411, 1412 and bands 1421, 1422.

FIG. 14 illustrates a third source domain band 1413 of 32 values (values 33-63) being converted to a band 1423 of 16 values in the destination domain (values 32-47). The conversion between these bands 1413 and 1423 involves a different linear transform than for bands 1411, 1412 and bands 1421, 1422. The conversion between bands 1413 and 1423 will result in some information loss when the destination domain values in band 1423 are converted back to the source domain representations (band 1413).

FIG. 14 illustrates another source domain band 1414 of 64 values (values 63-127) being converted to a band 1424 of 16 values in the destination domain (values 48-63). The conversion between these bands 1414 and 1424 involves a different linear transform than for bands 1411-1413 and bands 1421-1423. The conversion between bands 1414 and 1424, when the destination domain values in band 1424 are converted back to the source domain representations (band 1414), will incur a greater degree of information loss than the conversions involving bands 1413 and 1423.

FIG. 14 illustrates another source domain band 1415 of 128 values (values 128-255) being converted to a band 1425 of 16 values in the destination domain (values 64-79). The conversion between these bands 1415 and 1425 involves a different linear transform than for bands 1411-1414 and bands 1421-1424. The conversion between bands 1415 and 1425, when the destination domain values in band 1425 are converted back to the source domain representations (band 1415), will incur a greater degree of information loss than the conversions involving bands 1413 and 1423 and bands 1414 and 1424.

FIG. 14 illustrates a further source domain band 1416 of 256 values (values 256-511) being converted to a band 1426 of 16 values in the destination domain (values 80-95). The conversion between these bands 1416 and 1426 involves a different linear transform than for bands 1411-1415 and bands 1421-1425. The conversion between bands 1416 and 1426, when the destination domain values in band 1426 are converted back to the source domain representations (band 1416), will incur a greater degree of information loss than the conversions involving bands 1413 and 1423, bands 1414 and 1424, and bands 1415 and 1425.

FIG. 14 illustrates another source domain band 1417 of 512 values (values 512-1023) being converted to a band 1427 of 16 values in the destination domain (values 96-111). The conversion between these bands 1417 and 1427 involves a different linear transform than for bands 1411-1416 and bands 1421-1426. The conversion between bands 1417 and 1427, when the destination domain values in band 1427 are converted back to the source domain representations (band 1417), will incur a greater degree of information loss than the conversions involving bands 1413 and 1423, bands 1414 and 1424, bands 1415 and 1425, and bands 1416 and 1426.

FIG. 14 illustrates a further source domain band 1418 of 1024 values (values 1024-2047) being converted to a band 1428 of 16 values in the destination domain (values 112-127). The conversion between these bands 1417 and 1427 involves a different linear transform than for bands 1411-1417 and bands 1421-1427. The conversion between bands 1418 and 1428, when the destination domain values in band 142\8 are converted back to the source domain representations (band 1418), will incur a greater degree of information loss than the conversions involving bands 1413 and 1423, bands 1414 and 1424, bands 1415 and 1425, bands 1416 and 1426, and bands 1417 and 1427.

In the application illustrated in FIG. 14, each motion vector can be stored using 16 bits (8 bits for each x, y component of the motion vector). Oftentimes, processors employ buses to access memory that is 32 bits wide. Thus, the proposed techniques permit two motion vectors to be loaded simultaneously to fully utilize such bus widths. This approach may benefit hardware implementations by reducing loading latency and by saving memory bandwidth.

The allocation of bands as shown in FIG. 14 leads to a further process conservation: The conversion between source domain representations and destination domain representations is performed by simple bit shifts rather than complicated division operations.

Although the transform function is shown and described as being applied to motion vector components, the principles of the present disclosure may find application with transform(s) that apply to other parameters used for motion compensation including those that use more advanced motion models, such as weights, offsets for weighted predictions, scaling parameters, and weight/offset for illumination warp parameters, as examples. Here again, source values of the weights, offsets, scaling parameters, and illumination warp weight/offset parameters may be subject to their own piece-wise linear transform to reduce the amount of memory consumed when these values are stored in a reference picture buffers 236 or 276 (FIG. 2).

Thus, when motion vector that is transformed according to the embodiment of FIG. 4 is stored in a reference picture buffer 236 or 276 (FIG. 2), the transformed motion vector conserves memory resources as compared to storage of the motion vector prior to transform.

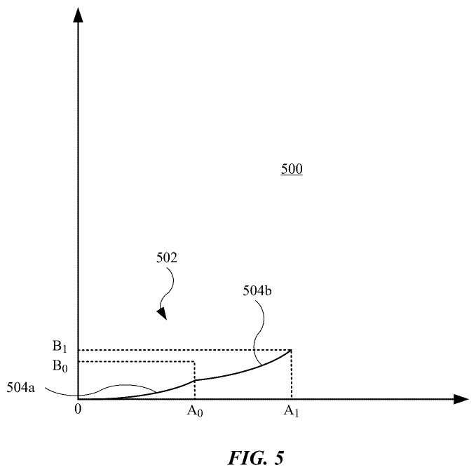

FIG. 5 illustrates a graph 500 showing another compression operation in accordance with aspects of the present disclosure. In this example, a motion vector component may be subject to a non-linear transformation that convers the motion vector component to a reduced-sized representation. For example, a non-linear transformation may operate as a power-law transformation, can be used as a predetermined transfer function and applied to compress the motion vector components in a manner similar to that of a piecewise linear transformation. The basic form of power-law transformation is shown as

$$Y = λ {X}^{θ} \qquad Eq . ( 2 )$$

where δ and θ are positive constant. These constants may be known to both an encoder and a decoder, such as by exchanging signaling that defines these constants, defining them in a governing coding protocol, or defining them impliedly based on other signaling parameters that are exchange between the encoder and decoder.

Similar to the piece-wise linear transformation, the power-law transformation approach allows storing small values of motion vector with high precision and large values of motion vector with lower precision.

For example, the graph 500 shows a plot 402 of a transform function f(A) governed by

$$f ( A ) = \{ \begin{matrix}Y = λ 1 {X}^{θ 1} & A < A 0 \\ Y = λ 2 {X}^{θ 2} & A 0 <= A < A 1\end{matrix} \qquad Eq . ( 3 )$$

where a segment 504a is a plot when A is less than A0, a segment 504b is a plot when A is greater than or equal to A0 and less than A1.

The techniques of FIGS. 4 and 5 may be used cooperatively. For example, in one or more implementations, a transform function may include a piece-wise linear component and non-linear component. Breakpoints between (e.g., A0, A1, etc.) between linear components and non-linear components may be defined in a governing protocol under which the encoder and decoder operate, they may be signaled by an encoder, or they may be signaled impliedly by deriving them from other coding parameters that are signaled by the encoder.

Motion vectors typically are multidimensional vectors having horizontal and vertical components, represented as an x component (mv_x) and a y component (mv_y). In an aspect, the transformation for one motion vector component (i.e., mv_y) can be derived depending on the value of the other motion vector component (mv_x). For example, if mv_x is small, there may be a higher likelihood that mv_y is also small, and this can be conditioned. Therefore, a transformation that compresses the input range to a smaller range could be used. Conversely, if mv_x is large, the precision of mv_y may be less critical, and this precision may be adjusted. In such cases, applying lower precision to the motion vector may facilitate reducing memory storage. Thus, when the transformed motion vector is stored in a reference picture buffer 236 or 276 (FIG. 2), the transformed motion vector conserves memory resources as compared to storage of the motion vector prior to transform.

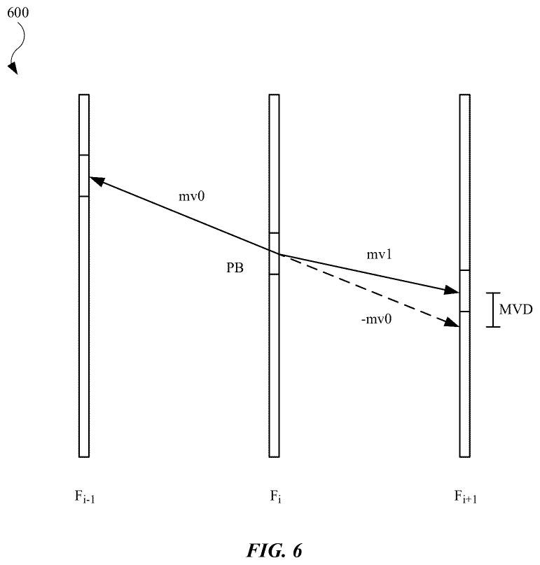

FIG. 6 illustrates a compression operation 600 according to another implementation of the present disclosure. FIG. 6 illustrates exemplary temporal relationships a frame being coded Fi and a pair of previously coded reference frames Fᵢ₋₁, Fᵢ₊₁. In this embodiment, a pair of motion vectors mv0, mv1, which may be used for bidirectional prediction of a pixel block PB, may be stored in a compressed representation in which one of the motion vectors is stored as a differential value mvd. In the example of FIG. 6, the motion vectors mv0 and mv1 represent motion vectors developed for a current pixel block PB, extending from a source frame Fᵢ to respective reference frames Fᵢ₋₁ and Fᵢ₊₁. Specifically, the motion vector MV0 identifies a location of a prediction pixel block for the pixel block PB taken from a first reference frame Fᵢ₋₁ (relative to reference frame Fᵢ) and the motion vector mv1 identifies a location of a prediction pixel block for the pixel block PB taken from a second reference frame Fᵢ₋₁ (relative to reference frame Fᵢ). The example of FIG. 6, thus, represents a bi-directional prediction of pixel block data, as the pixel block PB is to be predicted from pixel block data in a pair of reference frames Fᵢ₋₁, Fᵢ₊₁.

In an embodiment, to compress the representation of this pair of motion vectors mv0, mv1, the compression operation 500 may represent one of the motion vectors (here, mv1) differentially with respect to the other motion vector (mv0). The motion vector mv1 may be predicted as an inverse of the first motion vector mv0 (shown in phantom in FIG. 5), and a differential motion vector mvd may be developed as a difference between the actual value of mv1 and its predicted value (e.g., mvd=mv1−mv0). The differential representation of mv1 may be stored in a reference picture buffer 236 or 276 (FIG. 2) along with the first motion vector mv0. In other words, the motion vector pair mv0, mvd may be stored in the reference picture buffer 236 or 276. The differential motion vector mvd typically has a reduced sized representation as compared to the source motion vector mv1 and, therefore, storage of the mv0, mvd pair is expected to conserve memory resources in the reference picture buffers 236, 276.

In existing video coding standards, if a block is coded as bi-prediction, two motion vectors are directly stored for the TMVP of future frames. Instead of directly storing the motion vector value for the second motion vector, the motion vector difference mvd between the first motion vector and the second motion vector can be computed first and then stored. The mvd can be computed as

$$M V D = MV 1 - MV 0 \qquad Eq . ( 4 )$$

where mv0 is a first motion vector for bi-prediction and mv1 is a second motion vector for bi-prediction. Usually, the value of mvd is smaller than the motion vector value (mv1) that it represents. Thus, it can achieve the compression purpose by reducing the storage size.

In an embodiment, mvd may be constrained to fit a predetermined bit width desired for storage in the reference picture buffer 236 or 276 (FIG. 2). In such an embodiment, if mvd is larger than a defined threshold, its value can be quantized or clamped to a maximum value allow by the desired bit depth. In the example of FIG. 6, the mvd (e.g., differential representation between −mv0 and mv1) can be stored (e.g., in reference picture buffers 236 and 276 in FIG. 2) as well as one of mv0 or mv1, and the memory requirements for storing mvd and one of the motion vectors is less than that for both motion vectors.

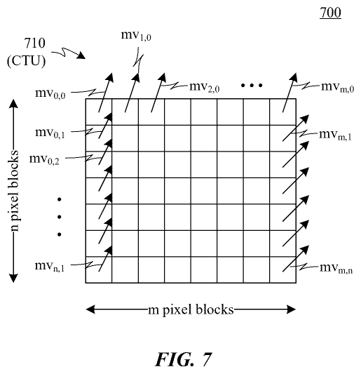

FIG. 7 illustrates a compression operation 700 according to a further aspect of the present disclosure. Here, FIG. 7 provides a spatial representation of pixel blocks in a frame 600 that are coded using motion vectors. In this aspect, motion vectors of the pixel blocks that belong to a common coding unit 710 (such as a coding tree unit) may be coded differentially to conserve resources when those motion vectors are stored in a reference picture buffer 236 or 276 (FIG. 2).

As discussed, when pixel blocks are coded by a frame encoder 232 (shown in FIG. 2), a prediction data compressor may develop motion vectors for those pixel blocks that identify sources of prediction for the pixel blocks. Pixel blocks may be members of a hierarchy of coding units, such as coding tree units. FIG. 7 illustrates one such application of this hierarchy, where an mxn array of pixel blocks are shown as members of a common coding unit 710. Motion vectors mv_{0,0} to mv_{m,n} may be developed for the pixel blocks.

In an embodiment, motion vectors of select pixel blocks may be represented in differential fashion with reference to a predicted motion vector. In one implementation, for example, a first motion vector mv_{0,0} of the coding unit 710 may be stored in its source representation. Other motion vectors mv_{1,0} to mv_{m,n} may be stored in a differential representation according to:

$$m v {d}_{i , j} = m {v}_{i , j} - m v {d}_{0 , 0} , for all i , j . \qquad Eq . ( 5 )$$

It is expected that the mvd values will consume fewer resources when stored in a reference picture buffer 236 or 276 (shown in FIG. 2) than would storage of the motion vector values in their source representation.

In this embodiment, also, mvd values may be constrained to fit a predetermined bit width desired for storage in the reference picture buffer 236 or 276 (FIG. 2). In such an embodiment, if an mvd value is larger than a defined threshold, its value can be quantized or clamped to a maximum value allow by the desired bit depth.

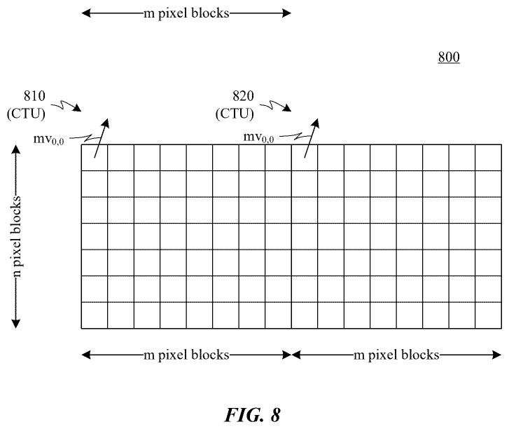

FIG. 8 illustrates a compression operation 800 according to another aspect of the present disclosure. Here, FIG. 8 provides a spatial representation a pair of coding units 810, 820 from an exemplary frame 800. According to this embodiment, a first motion vector mv_{0,0} of one coding unit 820 may be coded differentially with respect to a first motion vector mv_{0,0} of another coding unit 810 from the frame 800, for example, an immediately adjacent coding unit. In this example, the mv_{0,0} value of the coding unit 820 may be stored as a differential motion vector derived as follows:

$$m v {d}_{0 , 0 , CU 820} = m {v}_{0 , 0 , CU 820} - m {v}_{0 , 0 , CU 820} . \qquad Eq . ( 6 )$$

Storing the motion vector mv_{0,0} of coding unit 820 in a differential representation is expected to conserve resources in the reference picture buffer 236, 276 (FIG. 2) as compared to storage of the motion vector in its source representation. Here, again, mvd values may be constrained to fit a predetermined bit width desired for storage in the reference picture buffer 236 or 276 (FIG. 2). In such an embodiment, if an mvd value is larger than a defined threshold, its value can be quantized or clamped to a maximum value allow by the desired bit depth.

The techniques of FIGS. 7 and 8, of course, can be used cooperatively. In such an implementation, a first motion vector mv_{0,0} of a first coding unit 810 may be stored in a source representation or perhaps a transformed representation obtained by one of the foregoing FIGS. 4-7. Motion vectors of other pixel blocks in the first coding unit 810 may be stored in a differential representation according to the teachings of FIG. 7 and Equation 4. A first motion vector mv_{0,0} of a second coding unit 820 may be stored in a differential representation according to the teachings of FIG. 8 and Equation 5. Motion vectors of other pixel blocks in the second coding unit 720 may be stored in a differential representation according to the teachings of FIG. 7 and Equation 4. In this manner, the principles of the present disclosure are expected to yield compounded savings of memory resources in a reference picture buffer 236, 276 (FIG. 2).

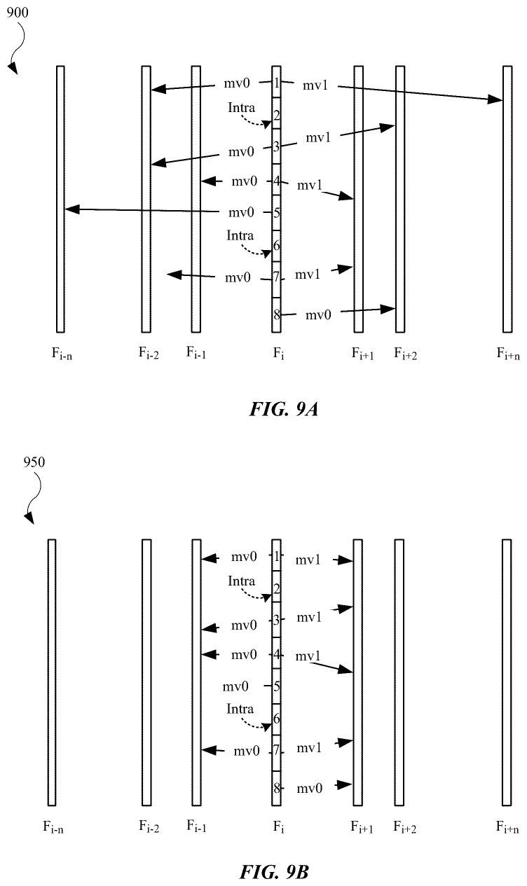

FIG. 9A and 9B illustrate compression operations according to yet another aspect of the present disclosure. In this variant, prediction references may be transformed to delete use of reference frame identifiers (ref_idx) and to scale motion vectors, where applicable, to refer to immediately adjacent reference frames. FIG. 9A illustrates exemplary motion vectors that extend between a frame being coded Fi and other reference frames Fᵢ₋ₙ, Fᵢ₋₂, Fᵢ₋₁, Fᵢ₊₁, Fᵢ₊₂, Fᵢ₊ₙ. As shown in this example, some pixel blocks (e.g., nos. 1, 3, 4, and 7) are shown as predicted using a pair of motion vectors. Other pixel blocks (nos. 5 and 8) are shown as predicted using a single motion vector. In each case, the motion vector may include not only a spatial vector but also a reference frame identifier (ref_idx) that identify to which of the reference frames Fᵢ₋ₙ, . . . , Fᵢ₋₂, Fᵢ₋₁, Fᵢ₊₁, Fᵢ₊₂, . . . , Fᵢ₊ₙ the motion vector refers. In existing video coding standards, constructing TMVP requires storing not only the motion vectors but also the reference frame index of each coding block. Multiple reference frames are allowed for coding a frame in these existing standards. For instance, HEVC/VVC allows 16 reference frames, while AV1 and AVM allow 7 reference frames. Consequently, several bits are consumed to store the reference frame index.

According to an aspect, shown in FIG. 9B, source prediction references may be compressed by dropping from the prediction references the reference frame identifiers and by scaling the motion vectors. Motion vector may be performed according to predetermined rules. For example, the motion vectors can be temporally scaled to a fixed temporal distance. For example, all motion vectors that refer to “past” temporal locations Fᵢ₋ₙ, Fᵢ₋₂, Fᵢ₋₁ may be scaled so that they refer to a reference frame at a fixed temporal distance from the current frame Fᵢ. Alternatively, if both past and future frames exist, the motion vectors can be temporally scaled to the nearest past and nearest future frames; otherwise, they can be temporally scaled to the nearest two past frames. FIG. 9B illustrates an example of temporally scaling the motion vectors to the nearest past and nearest future frames. Based the scaling, the motion vectors in FIG. 9B are normalized to point to particular reference frames. As shown, the mv0 motion vectors are scaled to Fᵢ₋₁ and the mv1 motion vectors are scaled to Fᵢ₊₁. The scaling operation may refer to a normalizing operation in which the direction of the motion vectors is unchanged. By scaling the motion vectors, the index need not be stored, and the reduced-sized representation of the prediction references, as stored, lacks the index. The foregoing operations may be used for future processing subsequent to decoding a frame(s).

In another aspect, for one or more motion vectors, compressing the pixel blocks' prediction reference(s) may include storing the motion vector in a floating point representation. Floating-point numbers of data representation, such as IEEE754, can be applied to compress the motion vector data. As an example, floating-point numbers of data representation are expressed as Mantissa-Exponent pairs, as shown below.

$$0.0253 = \underbrace{2.53}_{Mantissa} * \underbrace{{10}^{- 2}}_{Exponent} \qquad Eq . ( 7 )$$

where the first part, the Mantissa, defines the non-zero part of the number. The second part, the Exponent, defines how many positions after the decimal point are to be kept. Floating-point numbers of data representation can coarsely quantize larger values of motion vectors while retaining high precision for smaller values of motion vectors. In one embodiment of motion vector representation, the Mantissa may be a K-bit signed integer value including 1 bit for the sign, and the Exponent may be a L-bit unsigned integer. The value of (K+L) is smaller than N, which is the number of bits required to represent the original value of the MV component. When calculating the Mantissa from the original value of MV component, a particular rounding method may be applied. In one example, the rounding may be always towards zero. In another embodiment, the rounding may always be towards larger magnitude.

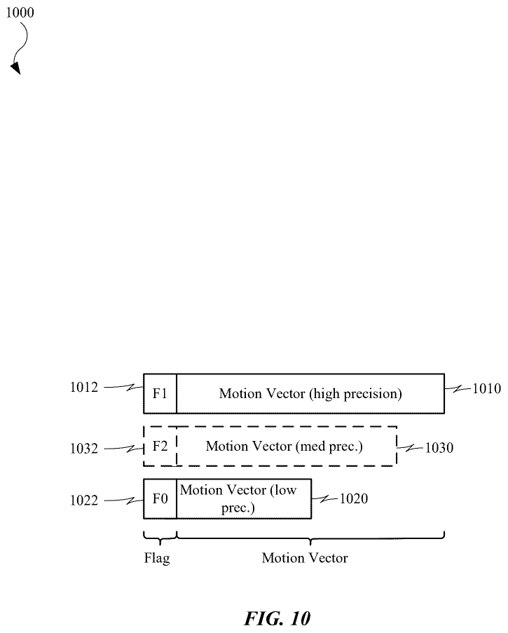

FIG. 10 illustrates a compression operation 1000 may be achieved by varying a precision of a motion vector according to observed motion within frame content according to aspects of the present disclosure. It often occurs that video frames exhibit completely different characteristics across a video sequence, for example, scene to scene. Some frames may contain static or small motion, while others may contain significant motion. Thus, the magnitudes of the motion vectors also may vary across different frames. To mitigate the coding efficiency loss caused by the precision of the motion vectors and to reduce the memory size requirement of MV storage, high precision motion vectors 1010 can be used for video frames that contain static or small motion, while low precision motion vectors 1020 can be used for video frames with significant motion, such as illustrated in FIG. 10. To achieve this purpose, sequence/frame/tile level flags and/or parameters can be implemented to control motion vector precision for each frame. This provides the feasibility for hardware to control how many bits are retained, and if the value of a motion vector component exceeds the maximum value defined by the precision, clipping operations can be applied to limit it within the valid range.

The use of flags in elements such as coding units may indicate whether there is a relatively high or low precision. During operation, a coding system 230 (FIG. 2) may generate motion observations for input frames 210. A prediction data compressor 242 (FIG. 2) may alter source motion vectors according to the observed motion and alter precision of the source motion vectors. In one aspect, motion that falls below a predetermined threshold may be assigned to a high precision motion vector format 1010 and stored in a representation having a relatively high bit width. Motion that falls below the predetermined threshold may be assigned to a low precision motion vector format 1020 and stored in a representation having relatively low bit width. Flags 1012, 1022, and 1032 may assigned to the stored motion vectors to indicate which representation has been used. Of course, the proposed techniques are not limited solely to two representations of motion vector precision; one or more motion vector representations (shown as 1030) may be employed having precisions intermediate to the high and low precision formats. The number of representations and the bit widths assigned to those representations may be tailored to fit individual application needs.

In another embodiment, the precision of MVs may be controlled at the MV storage unit level within the reference picture buffer(s) 236, 276 (FIG. 2). In this implementation, the precision of motion vectors may be defined for each of a plurality of memory storage locations (a storage unit) within the reference picture buffer(s) 236, 276 with a respective flag provided to indicate the precision at which each motion vector stored within that unit. When a flag is set indicating use of high-precision motion vectors, it may indicate that the motion vector components stored within that unit all employ the high precision representation. Conversely, when a flag is set indicating use of low-precision motion vectors, it may indicate that the motion vector components stored within that unit all employ the low precision representation.

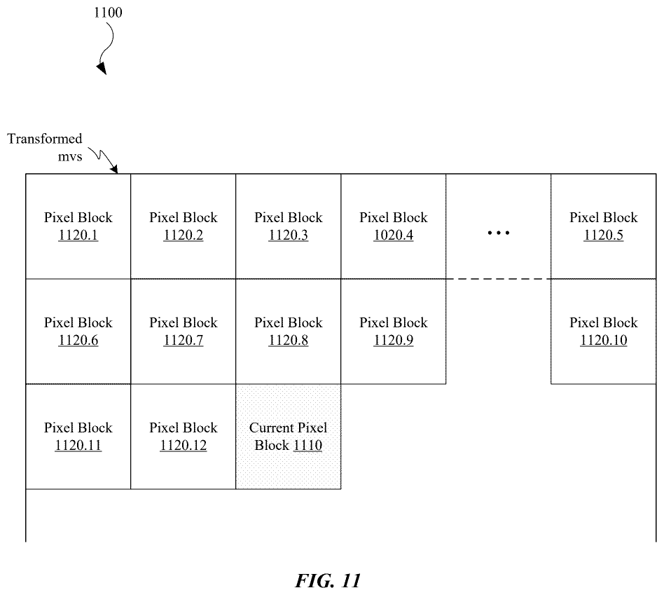

FIG. 11 illustrates a compression operation according to another aspect of the present disclosure. In this aspect, motion vector transformations are applied to pixel blocks when motion vectors from those pixel blocks no longer are used for coding. FIG. 11 illustrates a frame 1000 that contain a variety of pixel blocks. The example of FIG. 11 illustrates a circumstance where a current pixel block 1110 is being coded and other pixel blocks 1120.1-1120.12 of the frame have been coded. In this example, decoded frame data representing those other pixel blocks 1120.1-1120.12 are available in the reference picture buffers 236, 276 (FIG. 2) and they may be available as source of prediction for SMVP. This is consistent with video coding/decoding systems that process pixel blocks in raster scan order. In this embodiment, prediction data compression may be performed when a coding operation moves away from stored pixel blocks such that the pixel blocks' motion vectors are no longer used for coding. In this manner, the pixel blocks' motion vectors may be safely altered to reduce memory requirements.

Consider the raster-scan operation shown in FIG. 11. Pixel blocks that are spatially displaced from a pixel block 1110 that currently is being coded may be designated as no longer used for coding. In this example, the spatial displacement is the size of pixel block. Thus, pixel blocks 1120.1-1120.6, which are displaced from the current pixel block 1110 by a pixel block width may be designated as no longer used for coding, and transformations of those pixel block's prediction data may be performed.

In this example, pixel block 1120.11 also is spatially displaced from the current pixel block 1110 by more than the width of a single pixel block. The raster-scan coding direction of this example eventually will cause coding to advance from a row in which pixel block 1110 is located to a next row. When that row advance occurs, pixel block 1120.11 will be within the threshold distance of a current coding block at that time. Thus, the prediction data of pixel block 1120.11 may be deferred until such time as it will be no longer used for coding of any pixel block of a frame 1100.

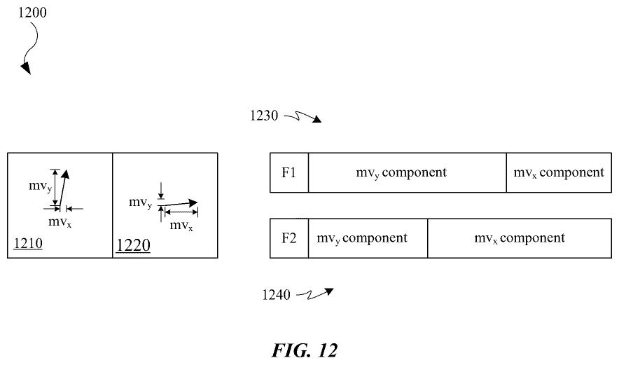

FIG. 12 illustrates a compression operation according to another aspect of the present disclosure. In this embodiment, motion vector precision may be controlled dynamically based on relative magnitudes of x and y components of the motion vector. It often occurs in video that motion may occur predominantly in one motion vector component, either the horizontal (e.g., x) component or the vertical (e.g., y) component, as compared to the other motion vector component. In such cases, the motion vector component with a small value may not be stored in a reduced-sized representation as compared to its source representation. Consequently, some (e.g., one or more) bits from the motion vector component with a small value can be allocated to the motion vector component with a large value when it is stored. This approach allows for different precision levels for the horizontal and vertical components of motion. It achieves the compression purpose for motion vectors without compromising the precision of one component when the value of another component is very small. In one example, one or more high level (e.g., frame level) syntax may be used to indicate which direction of the MV component needs more bits, and how many additional bits to be allocated to that direction. Alternatively, a flag may be set with the stored data of the motion vector that indicates a representation that is used for the motion vector.

FIG. 12 illustrates an exemplary set of pixel blocks 1210, 1120 to illustrate this approach. In pixel block 1210, a y component of the motion vectors has a greater magnitude than the x component. Its motion vector may be stored in a representation 1230 that assigns a larger number of bits to the y component of the motion vector than the x component. In pixel block 1220, an x component of the motion vectors has a greater magnitude than the y component. Its motion vector may be stored in a representation 1240 that assigns a larger number of bits to the x component of the motion vector than the y component.

The overall size of the representations 1230, 1240 may be set to be smaller than the aggregate sizes to the motion vectors in their source representation. Accordingly, the flexibility of altering the bit depth of the of the horizontal or vertical component of a motion vector allows a system to save memory resources. Systems described herein may utilize control signals to control one component differently from the other the other component.

In another embodiment, encoders and decoders (FIG. 2) may synchronize operations to omit storage of prediction data for select frames from their reference picture buffers 236, 276 (FIG. 2) In one embodiment, the encoder and decoder may operate according to a common set of rules that determine which frames have prediction data stored in the reference picture buffers and which do not. For example, rules may be triggered based on analysis of frame content such as by motion type, motion magnitude, resolution, frame rate, etc., which may be signaled at relatively high-level syntax elements within a coding sequence, for example, at the sequence level, frame level, or tile level, or this information could be derived at the decoder. When prediction data is not stored for a given frame, prediction information (such as motion information) can be derived (e.g., interpolated) at the decoder from data of other frames. In another implementation, an encoder may constrain use of prediction data so that prediction data is not used for frames where it is not stored.

In another embodiment, encoders and decoders (FIG. 2) may synchronize operations to flush prediction data for select frames from their reference picture buffers 236, 276 (FIG. 2) In one implementation, an encoder may send a predetermined signal to a decoder that indicates the prediction data of an identified reference frame is to be deleted from the decoder's reference picture buffer 276. In another implementation, the encoder may send a predetermined signal to a decoder that indicates that prediction data of all previously-stored reference frames is to be deleted from the decoder's reference picture buffer 276. In another implementation, encoders and decoders may store motion maps in lieu of prediction data for select frames. A motion map may indicate, for spatial locations throughout a stored reference frame, whether motion is non-zero or not. For area(s) with non-zero motion, the motion map would not provide information regarding the motion's characteristics. The motion, therefore, is unknown and it could not be used as a temporal predictor. These approaches provide the benefit of easily controlling the overall memory size based on the system capacity.

Storing the motion vectors of all reference frames will consume a significant amount of memory, especially for high-resolution video. In another embodiment, to save memory, subsampling can be done on the motion information before it is saved for the TMVP of future frame. Different filtering algorithms could be used when downsampling the motion field to maintain better correlation of the motion field. When utilizing the motion vectors as temporal predictors, instead of using the vectors directly at the reduced resolution, the motion field could be interpolated to obtain better quality motion vectors for temporal predictors. Different types of interpolation filters could be used here, such as bilinear, bicubic, cosine-based filters, etc. The filter can be applied in the spatial and/or temporal domain. Using this approach, pixel blocks may be stored as relatively coarser blocks sizes and the motion vectors may be interpolated.

In another embodiment, the MV storage unit size may be defined by a high level (e.g., frame level or tile level) syntax. For example, the MV storage unit size may be selected among 4×4, 8×8, or 16×16 in luma samples.

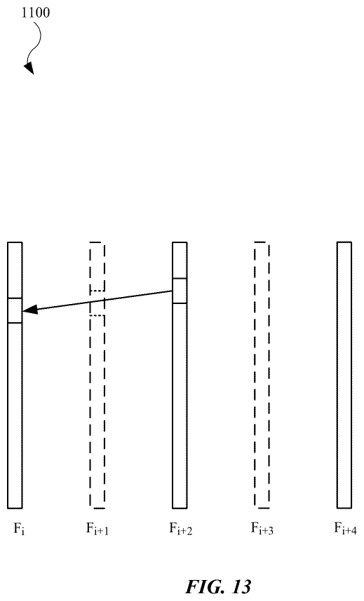

FIG. 13 illustrates a diagram 1300 of reference frames, showing an approach for compressing prediction data, in accordance with aspects of the present disclosure. Rather storing the motion vectors for all coded frames, storing of the motion vectors for some frames may be skipped and instead the motion vectors of the closest temporal neighboring reference frames may be used to interpolate the motion vectors for these skipped frames for TMVP. In the example illustrated in FIG. 13, the motion vectors of even frames (e.g., frames Fi, Fi+2, Fi+4) are not stored. When TMVP needs to be built from the skipped even frame Fᵢ₊₂, motion vector(s) frame Fᵢ₊₂ may be interpolated using motion vector(s) from a collocated position in the closest temporal neighboring frame Fᵢ₊₂ to estimate that frame's motion vectors. Thus, a motion vector for a pixel block 1110 in frame Fᵢ₊₂ may be interpolated using a co-located pixel block 1120 in frame Fᵢ₊₁.

The foregoing approaches can be applied to the tiles or subpictures. This is because the motion in some tiles or subpictures may be small, but large in other tiles or subpictures. Having separate precision control for each tile or subpicture can help maintain precision while reducing the memory size.

The above-mentioned methods can significantly reduce the memory size needed for storing motion vectors and can also reduce the memory bandwidth required to load these motion vectors for building a motion vector prediction list. These methods can be utilized not only in the context of video coding but also in other applications that may generate motion vectors using block-based methods and rely on predictive motion estimation schemes to generate motion fields. In such cases, motion vector predictor candidates may also be generated and stored.

This aspect can be used not only for coding applications of video data but also for processing applications that utilize motion-based approaches for processing, such as motion-compensated temporal filtering for deinterlacing, denoising, scaling, etc. The techniques could also be applied in a variety of applications such as scalable and multi-view video coding, coding of point clouds or mesh information based on video coding methods (e.g., using the V3C/V-PCC specifications), and more.

The foregoing discussion has described operation of the aspects of the present disclosure in the context of video coders and decoders, such as those depicted in FIG. 2. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically include instructions stored in non-transitory physical storage media such as electronic, magnetic, and/or optically-based storage devices, where they are read by a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

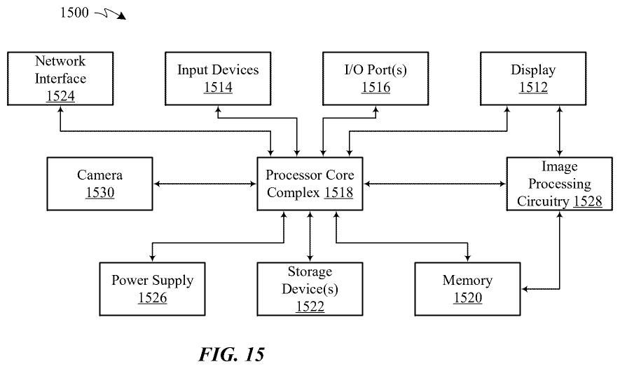

FIG. 15 is a block diagram of an electronic device 1500. The electronic device 1500 may take any form, such as a computer, a mobile phone, a portable media device, a tablet, a television, a virtual-reality headset, a wearable device such as a watch, a vehicle dashboard, or the like. FIG. 15 is merely one example of a particular implementation and is intended to illustrate the types of components that may be present in an electronic device 1500.

The electronic device 1500 includes an electronic display 1512, input devices 1514, input/output (I/O) ports 1516, a processor core complex 1518 having processing circuitry such as one or more central processing unit (CPU) and/or graphics processing unit (GPU) cores, local memory 1520, a main memory storage device 1522, a network interface 1524, a power source 1526 (e.g., power supply), image processing circuitry 1528, and a camera 1530. The various components described in FIG. 15 may include hardware elements (e.g., circuitry), software elements (e.g., a tangible, non-transitory computer-readable medium storing executable instructions), or a combination of both hardware and software elements. The various depicted components may be combined into fewer components or separated into additional components. For example, the local memory 1520 and the main memory storage device 1522 may be included in a single component. Moreover, the electronic device 1500 may include more or fewer components than those depicted here.

The processor core complex 1518 is operably coupled with local memory 1520 and the main memory storage device 1522. Thus, the processor core complex 1518 may execute instructions stored in local memory 1520 and/or the main memory storage device 1522 to perform operations, such as generating or transmitting image data to display on the electronic display 1512 and/or receiving image data generated by the camera 1530. As such, the processor core complex 1518 may include one or more processors, one or more general purpose microprocessors, one or more application specific integrated circuits (ASICs), one or more field programmable gate arrays (FPGAs), or any combination thereof. In some embodiments, various components of the electronic device 1500, including the processor core complex 1518, may be part of a system on a chip (SoC) of the electronic device 1500. Although depicted as a separate component in FIG. 15, the image processing circuitry 1528 may be part of the processor core complex 1518.

In addition to program instructions, the local memory 1520 or the main memory storage device 1522 may store data to be processed by the processor core complex 1518. Thus, the local memory 1520 and/or the main memory storage device 1522 may include one or more tangible, non-transitory, computer-readable media. For example, the local memory 1520 may include random access memory (RAM) and the main memory storage device 1522 may include read-only memory (ROM), rewritable non-volatile memory such as flash memory, hard drives, or the like.

The network interface 1524 may communicate data with another electronic device or a network. For example, the network interface 1524 (e.g., a radio frequency system) may enable the electronic device 1500 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 1526 may provide electrical power to one or more components in the electronic device 1500, such as the processor core complex 1518, the electronic display 1528, and/or the camera 1530. For example, the power source 1526 may include a power supply rail and/or a ground terminal coupled to the one or more components in the electronic device 1500, such as the processor core complex 1518, image processing circuitry 1528, and/or the camera 1530 to provide the electrical power. Thus, the power source 1526 may include any suitable source of energy, such as a rechargeable lithium polymer (Li-poly) battery or an alternating current (AC) power converter.

The I/O ports 1516 may enable the electronic device 1500 to interface with other electronic devices. In one example, when a portable storage device is connected to one of the I/O ports 1516, the I/O port 1516 may enable the processor core complex 1518 to send data to or receive data from the portable storage device. In another example, when an external electronic display is connected to one of the I/O ports 1516, the I/O port 1516 may enable the electronic device 1500 to provide image data to display on the electronic display. The input devices 1514 may enable user interaction with the electronic device 1500, for example, by receiving user inputs via a button, a keyboard, a mouse, a trackpad, or the like. The input device 1514 may include touch-sensing components in the electronic display 1512. The touch sensing components may receive user inputs by detecting occurrence or position of an object touching the surface of the electronic display 1512.

Image data that may be displayed on the electronic display 1512 may be come from any suitable image source, such as an application processor or graphics processing unit (GPU) of the processor core complex 1518, the memory 1520, the storage 1522, or an image sensor of the camera 1530. Additionally, in some cases, image data may be received from another electronic device 1500 via the network interface 1524 or an I/O port 1516. The image processing circuitry 1528 may process the image data in a variety of ways. The image processing circuitry 1528 may encode images for efficient storage or transmission, decode encoded images, scale or rotate images, or prepare image data for display on the electronic display 1512.

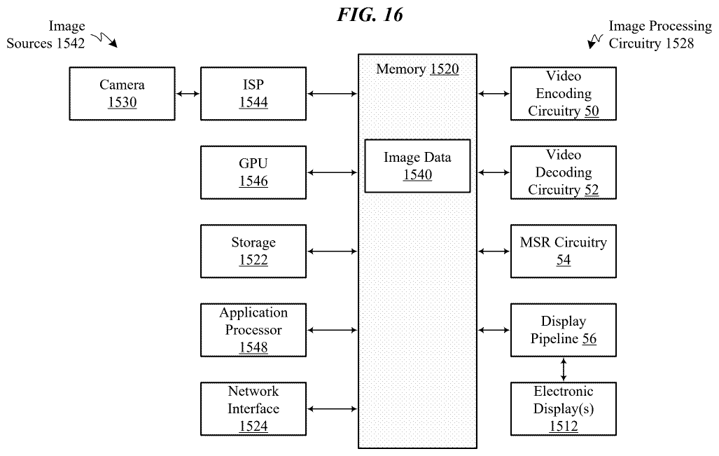

As shown in FIG. 16, the image processing circuitry 1528 may include hardware accelerators to perform a variety of image processing operations on image data 1540 fetched from the memory 1520. The image data 1540 may come from a variety of image sources 1542, which may differ depending on the form of the electronic device. A non-exhaustive list of image sources 1542 that may supply the image data 1540 include an image signal processor (ISP) 1544 coupled to a camera 1530, a graphics processing unit (GPU) 1546 (e.g., of the processor core complex 1518 shown in FIG. 15), the storage 1522, an application processor 1548 (e.g., of the processor core complex 1518 shown in FIG. 151), or the network interface 1524. The image data 1540 may be an entire frame of image data that could be displayed on the electronic display 1512 or may be smaller or larger. For example, the image data 1540 may be a photo, a frame of a video, a frame of image data for display on the electronic display 1512, encoded video data to be decoded, to provide a few examples.

The image processing circuitry 1528 may include specialized accelerator circuits to perform certain image processing tasks on the image data 1540 in a much more power-and area-efficient manner than exclusively relying on software running on the application processor 1548. For example, video encoding circuitry 1550 may retrieve frames of the image data 1540 as part of a video stream and encode them for much more efficient storage or transmission according to the techniques described hereinabove (FIGS. 3-13). When the image data is encoded, video decoding circuitry 1552 may decode the image data 1540. Memory-to-memory scaler and rotator (MSR) circuitry 1554 may scale, rotate, and enhance the image data 1540. A display pipeline 1556 may prepare the image data 1540 for display on the electronic display 1512.

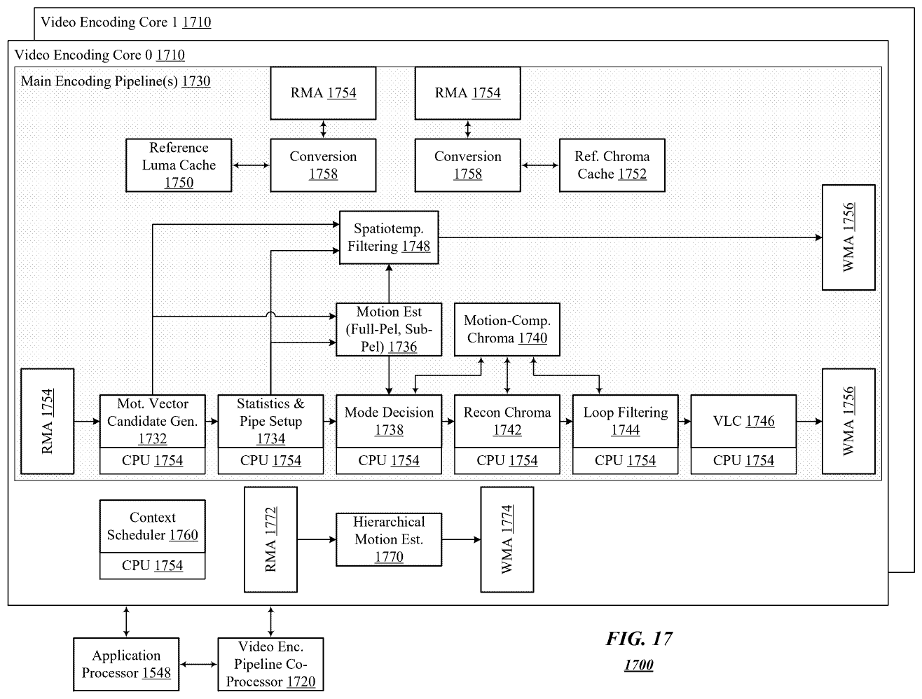

FIG. 17 is a block diagram of an example of the video encoding circuitry 1700. In other examples, there may be more or fewer components than shown in FIG. 17. The video encoding circuitry 1700 may include any suitable number of video encoding cores 1710. In the example of FIG. 17, there are two video encoding cores 1710 illustrated as Video Encoding Core 0 and Video Encoding Core 1. In other embodiments, there may be more or fewer. For example, there may be only a single video encoding core 1710, three video encoding cores 1710, four video encoding cores 1710, eight video encoding cores 1710, sixteen video encoding cores 1710, or the like.

Each video encoding core 1710 may be controlled by a video encoding pipeline coprocessor 1720 that is controlled by the application processor 1548 (e.g., an application processor running in the processor core complex 1518 shown in FIG. 15). Additionally or alternatively, the application processor 1548 may directly control the video encoding cores 1710. The application processor 1548 may provide instructions and/or configuration, either directly or via the video encoding pipeline coprocessor 1720, for the video encoding cores 1710 to perform specific operations (e.g., HEVC encoding, H.264 encoding, motion-compensated temporal filtering (MCTF), green ghost mitigation (GGM)) on image data stored in a certain location in memory. The application processor 1548 and the video encoding pipeline coprocessor 1720 may include processors of any suitable instruction set architecture (e.g., a Reduced Instruction Set Computer (RISC)-based processor such as a RISC-V processor, an Advanced RISC Machine (ARM) processor, an x86-based processor) that execute instructions stored in a tangible, non-transitory, machine-readable medium (e.g., memory local to the processors, the memory 1520 or storage 1522 illustrated in FIG. 15).

Each video encoding core 1710 is formed from a number of functional blocks (e.g., circuitry to perform a particular image processing task). There may be numerous such blocks in a main encoding pipeline 1730. A context scheduler 1760 programs the various functional blocks with a context configuration, causing the functional blocks of the video encoding core 1710 to collectively perform a particular operation on a particular region of image data defined by the context. As used herein, one context refers to work on the same source picture, using the same reference pictures and same data buffers in memory for neighbor and collocated data, and sharing the same set of global parameters. In effect, a context is the smallest unit of work that can be scheduled on the video encoding core 1710. The blocks of the main encoding pipeline 1730 may operate in different modes (e.g., H.264 mode, HEVC mode, MCTF mode, GGM mode) depending on the context. Other functional blocks of the video encoding core 1710 include blocks outside of the main encoding pipeline 1730 such as hierarchical motion estimation circuits 1770.

The hierarchical motion estimation circuits 1770 operate as standalone memory-to-memory engines that retrieve data from memory via read memory access (RMA) circuitry 1772, scale and/or search and identify potential motion vector candidates in the image data and write the results to memory via write memory access (RMA) circuitry 1774. There may be multiple hierarchical motion estimation circuits 1770, such as a scaler that reads in source frame, downscales, and writes out (e.g., in a tiled interchange format); a full-search circuit that reads in (optionally downscaled) source and reference image data in tiled interchange format (written out by the scaler) and performs window-based full search; a recursive-search circuit that reads in (optionally downscaled) source and reference image data plus an input motion field (e.g., in tiled interchange format) and performs recursive refinement of the input motion field; and a dense motion vector circuit that reads in a motion field and writes out an interpolated version of the input motion field. The results of the various hierarchical motion estimation circuits 1770 may be used by other hierarchical motion estimation circuits 1770 or by the main encoding pipeline 1730.

The main encoding pipeline 1730 is a memory-to-memory engine that performs encoding or spatiotemporal filtering using a pipeline of functional blocks. When operating in a spatiotemporal filtering mode (e.g., MCTF, GGM), the main encoding pipeline 1730 outputs filtered samples of image data. The main encoding pipeline 1730 may include any suitable functional blocks. The functional blocks illustrated in FIG. 17 are intended to provide an example and are not exhaustive. The main encoding pipeline 1730 may include more or fewer and the functional blocks may be connected to one another in a variety of different ways.

As shown, the main encoding pipeline 1730 includes motion vector candidate generation circuitry 1732, statistics collection and pipeline setup circuitry 1734, full-pel and sub-pel motion estimation circuitry 1736, mode decision circuitry 1738, motion-compensated chroma circuitry 1740, chroma reconstruction (recon chroma) circuitry 1742, loop filtering circuitry 1744, and variable length coding (VLC) circuitry 1746. The main encoding pipeline 1730 also includes spatiotemporal filtering circuitry 1748 to perform motion-compensated temporal filtering (MCTF) or green ghost mitigation (GGM). The main encoding pipeline 1730 also includes cache memory to store components of reference image data for use by the various functional blocks of the main encoding pipeline 1730. This cache memory includes a reference luma cache 1750 to store reference luma components of image data being operated on by the main encoding pipeline 1730 and a reference chroma cache 1752 to store reference luma components of image data being operated on by the main encoding pipeline 1730. Contents of the luma cache 1750 and/or the chroma cache 1752 may be retrieved from off-chip memory as needed; reference frame data may be converted (block 1758) as described hereinabove to conserve resources expended during memory reads.

Some of the functional blocks of the main encoding pipeline 1730 may include a small central processing unit (CPU) 1754 that may manage the operations of its functional block based on locally stored firmware data. The CPU 1754 of the functional block may also generate firmware data to pass along to a subsequent functional block. The CPU 1754 may include one or more processors having any suitable instruction set architecture (e.g., a Reduced Instruction Set Computer (RISC)-based processor such as a RISC-V processor, an Advanced RISC Machine (ARM) processor, an x86-based processor) that execute instructions stored in a tangible, non-transitory, machine-readable medium (e.g., memory local to the processors, the memory 1520 or storage 1522 illustrated in FIG. 15). Some functional blocks, such as the motion estimation circuitry 1736 and the spatiotemporal filtering circuitry 1748, may not include a CPU 1754.

Various functional blocks of the main encoding pipeline 1730 read from or write to memory outside of the main encoding pipeline 1730 (e.g., the memory 1520 of FIG. 15) using read memory access (RMA) circuitry 1754 and write memory access (WMA) circuitry 1756. The motion vector candidate generation circuitry 1732, the statistics collection and pipeline setup circuitry 1734, the reference luma cache 1750, and the reference chroma cache 1752 may read from memory via RMA circuitry 1754. There may be other functional blocks, such as the spatiotemporal filtering circuitry 1748 and the loop filtering circuitry 1744, that also access memory directly via RMA circuitry 1754. The results of the main encoding pipeline 1730 from the VLC circuitry 1746 or the spatiotemporal filtering circuitry 1748 may be written out to memory via WMA circuitry 1756.

The main encoding pipeline 1730 may operate in several different modes based on the context that is configured into the various functional blocks by the context scheduler 1760. For example, the main encoding pipeline 1730 may operate in an encoding mode (e.g., H.264 or HEVC). Notably, rather than use multiple separate pipelines (e.g., one for each respective encoding format, H.264 and HEVC), the circuit blocks 1732, 1734, 1736, 1738, 1740, 1742, 1744, and 1746 of the main encoding pipeline 1730 may perform particular encoding operations for a particular encoding format based on the context that the context scheduler 1760 has programmed into them. In addition, when the main encoding pipeline 1730 is operating in an encoding mode, the spatiotemporal filtering circuitry 1748 may be deactivated (e.g., power gated, clock gated) and the circuit blocks 1732, 1734, 1736, 1738, 1740, 1742, 1744, and 1746 may operate on image data to produce VLC-encoded image data that is written to memory by WMA circuitry 1756. When the main encoding pipeline 1730 operates in a spatiotemporal filtering mode such as MCTF or GGM, the circuit blocks 1738, 1740, 1742, 1744, and 1746 may be deactivated (e.g., power gated, clock gated) and the circuit blocks 1732, 1734, 1736, and 1748 may operate on image data to produce filtered image data that is written to memory by WMA circuitry 1756.

The motion vector candidate generation circuitry 1732 is responsible for reading certain image data via the RMA 1754, such as neighbor pixel information, co-located pixel information, motion vector candidates (e.g., as determined by the hierarchical motion estimation circuits 1770), and firmware data for use by the local CPU 1754 of the motion vector candidate generation circuitry 1732. The motion vector candidate generation circuitry 1732 uses this data to generate motion vector candidates (e.g., selects from the motion vector candidates retrieved from memory, determines new motion vector candidates based on the retrieved motion vector candidates). The motion vector candidates are passed downstream to seed the motion estimation circuitry 1736 for full-pel (pixel) and sub-pel (sub-pixel) motion refinement. The motion vector candidates are also passed to the reference luma cache 1750 and the chroma reference cache 1752 to facilitate sample prefetch. The local CPU 1754 may be used to override default motion candidate generation and process incoming firmware data.

In FIG. 17, the statistics collection and pipeline setup circuitry 1734 is depicted as a single block, but may be divided into several functional blocks, some of which may have their own CPUs 1754. The statistics collection and pipeline setup circuitry 1734 reads source pixels, collects image statistics and performs certain calculations that will be used by subsequent functional blocks of the main encoding pipeline 1730, and relays certain image data to specific functional blocks of the main encoding pipeline 1730. The statistics collection and pipeline setup circuitry 1734 appears earlier in the main encoding pipeline 1730 in part to start fetching from memory so that the later functional blocks of the main encoding pipeline 1730 can access the source and reference image data sooner.

The motion estimation circuitry 1736 includes two components: full-pel (pixel) motion estimation circuitry and sub-pel (sub-pixel) motion estimation circuitry. The full-pel motion estimation circuitry performs integer-pixel motion refinement on the motion vector candidates it receives from the motion vector candidate generation circuitry 1732. The integer-pixel motion vector candidates from the full-pel motion estimation circuitry of the motion estimation circuitry 1736 are forwarded to the spatiotemporal filtering circuitry 1748 when the main encoding pipeline 1730 is operating in MCTF or GGM mode. When the main encoding pipeline 1730 is operating in an H.264 or HEVC encoding mode, the integer-pixel motion vector candidates from the full-pel motion estimation circuitry are provided to the sub-pel motion estimation circuitry of the motion estimation circuitry 1736. The sub-pel motion estimation circuitry of the motion estimation circuitry 1736 performs fractional pixel (sub-pixel) motion refinement on the integer-pixel motion vector candidates and forwards the refined motion vector candidates to the mode decision circuitry 1738.

The mode decision circuitry 1738 reads source samples and related pixel data (e.g., neighbor pixel data) from the statistics and pipe setup circuitry 1734 and reads motion vectors from the motion estimation circuitry 1736. Some neighbor data may also be retrieved directly from memory. The mode decision circuitry 1738 decides between intra and inter coding modes and sends the modes plus neighbor pixel data to the chroma reconstruction circuitry 1742, transform coefficients to the VLC circuitry 1746, and reconstructed plus source samples to the loop filtering circuitry 1744. The mode decision circuitry 1738 also forwards the determined modes and motion vectors to the motion-compensated chroma circuitry 1740 to facilitate chroma reference sample prefetch.

The motion-compensated chroma circuitry 1740 sends prefetch requests to the reference chroma cache 1752 and reads the resulting chroma reference samples. Using the chroma reference samples, as well as the modes and motion information from the mode decision circuitry 1738, the motion-compensated chroma circuitry 1740 produces chroma inter prediction samples. The chroma inter prediction samples are provided to the chroma reconstruction circuitry 1742.

The chroma reconstruction circuitry 1742 reads inter predicted samples from the motion-compensated chroma circuitry 1740, modes and motion from the mode decision circuitry 1738, and source samples from the statistics and pipe setup circuitry 1734. The chroma reconstruction circuitry 1742 uses this information to perform an intra mode decision for chroma samples. Thus, the chroma reconstruction circuitry 1742 determines a transform and quantization plus inverse transform and inverse quantization to derive chroma-reconstructed samples and transform coefficients. The samples are sent to the loop filtering circuitry 1744 while the coefficients are sent to VLC circuitry 1746.

The loop filtering circuitry 1744 may include a deblocking loop filter and an enhancement loop filter. The deblocking loop filter of the loop filtering circuitry 1744 receives luma reconstructed and source samples from the mode decision circuitry 1738 and chroma reconstructed and chroma source samples from the chroma reconstruction circuitry 1742. The deblocking loop filter of the loop filtering circuitry 1744 performs deblocking loop filtering for both H.264 and HEVC modes (reducing the appearance of block image artifacts). In HEVC mode, the deblocking loop filter of the loop filtering circuitry 1744 also performs a sample adaptive offset (SAO) parameter decision. Filtered samples and the SAO parameter syntax are provided to an enhancement loop filter of the loop filtering circuitry 1744. The SAO parameter syntax is also passed to the VLC circuitry 1744. The enhancement loop filter of the loop filtering circuitry 1744 receives filtered samples from the deblocking loop filter along with the SAO parameters and performs SAO filtering in HEVC mode. In H.264 mode, the enhancement loop filter may operate in a pass-through mode. The resulting samples from the enhancement loop filter may be written directly to memory via the WMA 1756.

The variable length coding (VLC) circuitry 1746 is responsible for compressing the modes and coefficients it has received from the mode decision circuitry 1738, the chroma reconstruction circuitry 1742, and the loop filtering circuitry 1744. In H.264 mode, the VLC circuitry 1746 produces a slightly modified context-aware variable length coding (CAVLC) bitstream that is written to memory via the WMA 1756. In HEVC mode, the VLC circuitry 1746 encodes the syntax bins as bits by skipping the arithmetic coding and the bitstream is written to memory via the WMA 1756. The local CPU 1754 is used primarily for gathering statistics and writing them to the memory via the WMA 1756.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. In a video coding system in which frames are coded predictively with reference to reference frames, a method of storing data representing a reference frame, comprising:
decoding coded pixel blocks of the reference frame according to coding modes of the coded pixel blocks, wherein at least one coded pixel block is coded predictively according to prediction data that refers to content from a previously-decoded reference frame to be used as a source of prediction for the coded pixel block;
developing a decoded reference frame from the decoded pixel blocks;
coding the pixel blocks' prediction data into reduced-sized representations; and
storing the decoded reference frame and the reduced-sized representation of the prediction data in a reference picture buffer.

2. The method of claim 1, wherein
the decoding and developing are performed by a processing device using prediction data in a full-sized representation, and p1 the storing stores the reduced-sized representation of the prediction data in a memory device remote from the processing device, and
when the processing device utilizes stored prediction data, it retrieves the reduced-sized representation of the prediction data and converts it to the full-sixed representation of the prediction data.

3. The method of claim 1, wherein the coded pixel blocks of the reference frame are generated by a coding operation that includes:
coding the pixel blocks according to their respective coding modes, wherein, for pixel blocks coded using a motion vector, the respective pixel blocks are coded differentially with reference to their prediction source, and the motion vector is generated by a prediction search that compares the respective pixel block of the reference frame to content of the prediction source.

4. The method of claim 1, wherein the coded pixel blocks, including their prediction reference(s) are received from a channel.

5. The method of claim 1, wherein the coding the pixel blocks' prediction data comprises, for a motion vector contained in at least one prediction reference, transforming the motion vector to a reduced-sized representation of the motion vector according to a predetermined transfer function.

6. The method of claim 5, wherein the predetermined transfer function is a piece-wise linear transfer function that relates a pre-coded representation of the motion vector to the reduced-sized representation of the motion vector.

7. The method of claim 5, wherein the predetermined transfer function is a power-law transformation function that relates a pre-coded representation of the motion vector to the reduced-sized representation of the motion vector.

8. The method of claim 5, wherein the predetermined transfer function assigned a relatively-higher number of quantization levels to motion vector values below a threshold value and a relatively-lower number of quantization levels to motion vector values above the threshold value.

9. The method of claim 1, wherein the coding the pixel blocks' prediction data comprises, for at least one motion vector, storing the motion vector in a differential representation with reference to another motion vector.

10. The method of claim 9, wherein the motion vector stored in the differential representation is a motion vector for a pixel block coded bi-directionally using a pair of motion vectors, and the motion vector stored in the differential representation is represented differentially with reference to another motion vector in the pair.

11. The method of claim 9, wherein the motion vector stored in the differential representation is a motion vector for a pixel block that belongs to a transform unit along with other pixel blocks, and the motion vector stored in the differential representation is represented differentially with reference to a motion vector of another pixel block in the transform unit.

12. The method of claim 9, wherein the motion vector stored in the differential representation is a motion vector for a pixel block that belongs to a transform unit along with other pixel blocks, and the motion vector stored in the differential representation is represented differentially with reference to a motion vector of a pixel block of another transform unit.

13. The method of claim 1, wherein at least one pixel block's prediction reference comprises an index identifying a source frame and a motion vector identifying a location within the source frame, and the reduced-sized representation of the prediction reference, as stored, lacks the index.

14. The method of claim 1, wherein the coding the pixel blocks' prediction data comprises, for at least one motion vector, storing the motion vector in a floating point representation.

15. A system, comprising:
a processing device; and
a memory storing program instructions that, when executed by the processing device, cause the processing device to code input video by:
decoding coded pixel blocks of the reference frame according to coding modes of the pixel blocks, wherein at least one coded pixel block is coded predictively according to a prediction reference that includes a motion vector;
developing a decoded reference frame from the decoded pixel blocks;
coding the pixel blocks' prediction reference(s) into reduced-sized representations; and
storing the decoded reference frame and the reduced-sized representation of the prediction reference(s) in a reference picture buffer.

16. The system of claim 15, wherein storing the reduced-sized representation comprises generating a flag based on a precision of the representation.

17. The system of claim 15, wherein storing the decoded reference frame and the reduced-sized representation comprises: allocating one or more bits from a first component of a motion vector to a second component of the motion vector.

18. The system of claim 15, wherein the decoded reference frame and the reduced-sized representation comprises determining, based a flag, whether to retain a motion vector in the reference picture buffer.

19. A non-transitory computer-readable medium, comprising:
computer-readable instructions that, when executed by a processor, cause the processor to perform one or more operations comprising:
decoding coded pixel blocks of the reference frame according to coding modes of the pixel blocks, wherein at least one coded pixel block is coded predictively according to a prediction reference that includes a motion vector;
developing a decoded reference frame from the decoded pixel blocks;
coding the pixel blocks' prediction reference(s) into reduced-sized representations; and
storing the decoded reference frame and the reduced-sized representation of the prediction reference(s) in a reference picture buffer.

20. The non-transitory computer-readable medium of claim 19, wherein storing the decoded reference frame and the reduced-sized representation comprises:
subsampling motion information; and
interpolating the motion vector.

21. The non-transitory computer-readable medium of claim 19, wherein storing the decoded reference frame and the reduced-sized representation comprising alternating storing of subsequent decoded reference frames in a predetermined manner.
